(19) United States
(12) Patent Application Publication
(10) Pub. No.: US 2010/0266774 A1
(43) Pub. Date: Oct. 21, 2010

(54) TEXTILE COATING METHOD WITH WATER URETHANE EMULSION

(76) Inventor: Ki Pyoung Yang, Daegu (KR)

Correspondence Address: CHRISTOPHER PAUL MITCHELL, 888 16TH ST., NW, SUITE 800, WASHINGTON, DC, 20006, US

(21) Appl. No.: 12/744,056

(22) PCT Filed: Jul. 21, 2008
(86) PCT No.: PCT/KR08/04247

§ 371 Date: May 20, 2010

(30) Foreign Application Priority Data
Nov. 20, 2007 (KR) 10-2007-0118788

(51) Int. Cl. B05D 3/10; B05D 3/12

(52) U.S. Cl. 427/358; 427/389.9

(57) ABSTRACT

Disclosed is a method of coating a textile with aqueous urethane textile having excellent water proofness and moisture permeability, wherein aqueous urethane coating agent prepared by employing a water dispersed polyurethane resin mixture and a thickener is applied to textile fabric, the coated fabric is heat dried, and then is hardened. Accordingly, the fiber product according to the present invention is very eco-friendly product, satisfies strict standard for an advance country since formalin is not detected, and in addition, has high functionality such as water proofness, moisture permeability and cleaning durability.

### TECHNICAL FIELD

The present invention relates to a method of coating a textile employing aqueous polyurethane having excellent water proofness and moisture permeability. In more particular, the present invention relates to a method of coating a textile with aqueous urethane having excellent water proofness, moisture permeability and cleaning durability, which can be generally used to a textile by using a coating agent comprising an eco-friendly water dispersed polyurethane mixture.

### BACKGROUND ART

The urethane industry in Korea has progressed around a material for a living article such as a cloth, a shoe, a bag, a toy, a sofa and a bed until 1980. At present, urethane is widely applied as a material for a heavy chemistry industry such as automobile, electronics, civil engineering and shipbuilding, and further a material for aerospace engineering and medical science. Also, in the fiber industry polyurethane coating technology is used thereby creating a new market called artificial leather industry.

An alternative is greatly required for the polyurethane industry that have progressed continuously due to occurrence of an environmental problem such as restriction for CFC used as a defoamer, disposal and recycling of wastes since late 1980. A need for eco-friendly aqueous polyurethane as such an alternative is progressively increased.

Various researches for making hydrophobic polyurethane into hydrophilic one according to such trend are disclosed. For example, a method that a hydrophilic group is incorporated into polyurethane backbone to prepare a self-emulsifiable resin, and then dispersing the resin in water (Japanese Patent Laid-Open Publication No. 1992-328187, and Japanese Patent No. 1993-43642), a method of dispersing hydrophobic polyurethane using much emulsifier (Japanese Patent Publication No. 1964-5989, and Japanese Patent Publication No. 1970-10957), a highly emulsifiable, stable polyisocyanate composition that a reaction between isocyanate group and water is controlled, and has high stability at water dispersed state (Korean Patent Laid-Open Publication No. 1999-7653), and a method of preparing water dispersed polyurethane in which aromatic-aliphatic isocyanate is hybridized (Korean Patent Laid-Open Publication No. 2005-6939), etc. are disclosed.

The previous oily polyurethane causes environmental problem due to use of organic solvents such as toluene, acetone, methylethyl ketone and cyclohexane in much amounts. Also, it basically contains formalin, and international permissive value is set as 30 ppm for infants, and 70 ppm for adults; however, an advanced country requires more strict standard in fiber products requiring eco-friendliness and high functionality.

Accordingly, water dispersed polyurethane recognized as an eco-friendly product is very urgently required; however, a fabric coated with aqueous polyurethane has many unsolved problems in water proofness, moisture permeability, cleaning durability, touch feel and workability, etc., and thus is not actually employed in fiber art.

### DISCLOSURE OF INVENTION

### Technical Problem

In order to solve the above problems, the present invention intends to provide a method of coating a textile with aqueous urethane having excellent water proofness, moisture permeability and cleaning durability, which can be generally used to a textile by using a coating agent comprising an eco-friendly water dispersed polyurethane mixture.

In addition, the present invention intends to provide a method of coating from which a textile has various functionality, by further adding zeolite, carbone, a fragrance capsule, an anti-bacterial agent, a smell removing agent, a deodorant, an aqueous pigment, aqueous silicone and pearl to the coating agent described above.

### Technical Solution

In order to achieve the above objects, according to one aspect of the invention, there is provided a method of coating a textile employing aqueous polyurethane comprising:

preparing a water dispersed polyurethane resin mixture comprising 30 to 50% by weight of a polyol using aliphatic isocyanate, 0.4 to 1% by weight of triethylamine as a chain extender, 2 to 3% by weight of N-methyldiethanolamine as an ionomer, and 46 to 67.5% by weight of water;

preparing a thickener comprising 28 to 30% by weight of an alkaline copolymer compound, 1 to 2% by weight of alkaline polyoxyethylene sodium sulfate, 0.05 to 0.1% by weight of potassium sulfate and 67.9 to 70.95% by weight of water; and then

mixing 3 to 5% by weight of a thickener and 30 to 80% by weight of water per 100% by weight of the water dispersed polyurethane resin mixture, and stirring the mixture thereby preparing a coating agent having a viscosity of 5,000 to 10,000 cps.

The aqueous urethane coating agent is applied to a pretreated textile fabric in a thickness of 20 to 100 g/yard with a float knife or an air knife, the coated textile was dried in heat drier at 130 to 150° C. for 40 to 90 seconds, and then was hardened at 130 to 170° C. for 30 to 60 seconds.

According to another aspect of the invention, there is provided a method of coating from which a textile has various functionality, by further adding 3 to 50% by weight of zeolite per 100% by weight of the coating agent, 5 to 25% by weight of carbone powders per 100% by weight of the coating agent, 0.5 to 5% by weight of a fragrance capsule in which a natural fragrance is encapsulated into a microcapsule per 100% by weight of the coating agent, 1 to 50% by weight of an anti-bacterial agent, a smell removing agent and a deodorant per 100% by weight of the coating agent, 1 to 50% by weight of an aqueous pigment per 100% by weight of the coating agent, 5 to 80% by weight of aqueous silicone per 100% by weight of the coating agent, and 0.1 to 10% by weight of pearl powders per 100% by weight of the coating agent to the coating agent prepared as described above.

### Advantageous Effects

A fiber product coated according to the present invention is a very eco-friendly product, satisfies strict standard for an advance country since formalin is not detected, and in addition, has high functionality such as water proofness, moisture permeability and cleaning durability.

Further, according to the present invention, coating work is possible under very comfortable condition since environmental pollution does not occur even in working environment; cost savings are achieved in high oil price era since water is used instead of oil.

In particular, the aqueous urethane coating agent according to the present invention can be generally applied to any textile fabric, and shows very soft touch to excellent surface slip property since the elasticity of a fiber is enhanced after coating. Further, working efficiency is greatly enhanced since tacky phenomenon does not occur on working, and chalk mark and needle trace do not remain when sewing a fiber product, thereby giving excellent workability.

In addition, since zeolite, carbone, a fragrance capsule, an anti-bacterial agent, a smell removing agent, a deodorant, an aqueous pigment, aqueous silicone and pearl are further added, moisture permeability, aerating property, and anion and far infrared function, etc. can be further obtained due to zeolite; electronic wave blocking and antistatic function can be further obtained by carbone powders; fragrance can be exited from a fiber, and antibacterial, smell removing and deodorant effects can be obtained with the fragrance capsule; various colors can be expressed by using the aqueous pigment; strength and elasticity can be enhanced by adding aqueous silicone; and visual property of a fiber can be improved by further adding pearl.

### MODE FOR THE INVENTION

The present invention provides a method of coating a textile employing aqueous polyurethane comprising:

preparing a water dispersed polyurethane resin mixture comprising 30 to 50% by weight of a polyol using aliphatic isocyanate, 0.4 to 1% by weight of triethylamine as a chain extender, 2 to 3% by weight of N-methyldiethanolamine as an ionomer, and 46 to 67.5% by weight of water;

preparing a thickener comprising 28 to 30% by weight of an alkaline copolymer compound, 1 to 2% by weight of alkaline polyoxyethylene sodium sulfate, 0.05 to 0.1% by weight of potassium sulfate and 67.9 to 70.95% by weight of water; and then

mixing 3 to 5% by weight of a thickener and 30 to 80% by weight of water per 100% by weight of the water dispersed polyurethane resin mixture, and stirring the mixture thereby preparing a coating agent having a viscosity of 5,000 to 10,000 cps.

The aliphatic isocyanate is a solid component and determines volume feel to thickness feel of a textile. If the concentration of the solid component is below 30% by weight, sufficient thickness feel cannot be ensured. If the concentration of the solid component exceeds 50% by weight greatly, it becomes difficult to disperse the polyurethane resin mixture.

The above-mentioned N-methyldiethanolamine is an ionomer and a material that works as not only a hydrophilic group for self-emulsification, but also a chain extender in a process of preparing polymer dispersion. The material influences viscosity, particle size and dispersion stability, and determines soft touch feel and softness in a textile with micro quantity. According to the present invention, if the material is used below 2% by weight, touch feel and softness become better; however, dispersibility becomes low. If the amount of the material exceeds 3% by weight, dispersibility is excellent; however, material property becomes stiff, and touch feel and softness become worse since particle size becomes small and thus viscosity becomes low.

The thickener is a material that controls the concentration of the polyurethane mixture in the present invention. If the thickener is added below 3% by weight per 100% by weight of the mixture, cleaning durability becomes good due to low viscosity; however, touch feel and softness become low since resin fluid is deeply infiltrated into textile organization. If the amount of the thickener to be added exceeds 5% by weight, softness becomes better; however, cleaning durability becomes low since the resin fluid is less infiltrated into textile organization.

Where viscosity is lower than 5,000 cps, touch feel becomes stiff since the coating agent is too much infiltrated into textile organization. Conversely, if viscosity is higher than 10,000 cps, the functionality that the present invention anticipates cannot be realized since it becomes difficult that the coating agent is infiltrated into textile organization. Accordingly, in consideration with textile property and required functionality, for example, for a textile requiring soft touch feel, it is necessary to adjust viscosity with a thickener and water lest viscosity should be low.

The coating agent according to the present invention can be applied to various fiber substrates. In particular, the fiber substrates includes a natural fiber such as hemp, silk and cotton, a synthetic fiber such as nylon, polyester, polyacryl, polyamide and polyvinyl chloride, a recycled fiber such as rayon and acetate, and linseys of the above fibers.

In order to apply a coating agent according to the present invention to a textile, various methods well known to the art can be performed. Firstly, a textile fabric is subjected to pretreatment such as refining, dyeing and water repelling; 20 to 100 g/yard of the coating agents in wet state are applied to the textile with a float knife or air knife; the coated textile is dried in heat drier at 130 to 150° C. for 40 to 90 seconds, and then the coated textile is hardened at 130 to 170° C. for 30 to 60 seconds.

The coating agent is applied in a thickness of 20 to 100 g/yds with the float knife or air knife having a thickness of 0.3 to 2.0 mm, and then the coated textile is dried in heat drier with 40 to 50 yard/min of an equipment speed at 130 to 150° C. for 40 to 90 seconds. Then, in order to ensure shape stability, the coated textile is secondly dried in a tenter machine with 50 to 80 yard/min of an equipment speed at 130 to 170° C. for 30 to 60 seconds.

By above process, coated textile product having excellent water proofness and moisture permeability that the present invention intends can be obtained, and water proofness test can be passed with only one-time coating. Coating frequency can vary somewhat according to the property and type of the textile fabric, and where perfect water proofness is required, for example, for rain clothes, 2 to 4 times of coating can be repeated.

Hereinafter, the present invention will be described in more detail with reference to examples. These examples have been included to illustrate modes of the presently disclosed subject matter. In light of the present disclosure and the general level of skill in the art, those of skill will appreciate that these examples are intended to be exemplary only and the scope of the present invention is not limited to these examples.

Various performance and properties in below examples were measured as described below through self-tests by the present inventors and the tests entrusted to Korea Yarn & Fabric Inspection Testing Institute.

(1) Water Proofness

Though test can vary depending on the properties of textile fabrics, when rain-water was sprayed at 2 feet high for 2 minutes in Rain Test based on AATCC clause 35 for once coating, the textile fabrics were passed since the weight of the moisture absorbing paper attached on the back surface of the textile fabrics did not exceed 1 g. From testing by controlling coating times at 2 to 4 times and applied amount, it was found that the more coating times and applied amount were, the higher water proofness was.

Those results show higher water proofness than when an oily urethane resin is used. This is why because its volatilizing point is lower than that of water since an oily product uses MEK, DMF or toluene as a solvent, and thus its drying speed is fast; however, due to that, surface smoothness becomes low, and thus water proofness becomes worse. Meanwhile, the water dispersed polyurethane coating agent according to the present invention has somewhat slow drying speed; however, a film is well formed on a fabric coating layer, and thus its water proofness is shown higher than that of an oily coating agent.

(2) Moisture Permeability Level

Moisture permeability level is very important functionality to fabrics. If the level is low, one feels uncomfortable since sweat generated in a human body on acting is not well exited. A fabric having high moisture permeability level can always maintain comfortableness even much sweat is exited. The test for moisture permeability level was ASTM E96-90 WATER METHOD, INVERTED CUP TYPE, and was performed under the condition at a temperature of 31 to 33° C., and a humidity of 49 to 51%.

The coating product according to the present invention maintains basic moisture permeability level at about 3,000 to 7,000 g/m²/24 h, and thus a separate moisture permeability coating is not necessary on coating general clothes.

For a previous oily urethane resin, the type of a resin or a coating method should be varied according to required moisture permeability since the moisture permeability varies greatly from no level to high level depending on the type of coating. However, for coating method according to the present invention, a moisture permeability of about 3,000 to 7,000 g/m²/24 h is basically ensured.

The reason why such moisture permeability level can be ensured is because the resin according to the present invention has hydrophilic group; and very fine particles positioned before water was dried are dried, and minute pores are formed at places where water was positioned, and then sweat is exited between such pores.

(3) Cleaning Durability

The test for color fastness to cleaning was performed at KSK0430 (40° C.), and confirms that the dyed color of a fabric is not decolorized or discolored by cleaning. Further, test conditions described in AATCC clause 61 for water cleaning and AATCC clause 132 for dry cleaning are satisfied in the above test.

A previous oily urethane coating should have sorted out the cleaning method by water cleaning and dry cleaning according to the coating type, and sorted temperature conditions (water or drying temperature, etc.). However, it was shown that the textile product coated according to the present invention is applicable to both the water cleaning and dry cleaning, and in particular suitable to dry cleaning.

(4) Eco-Friendliness

The amount of formaldehyde (mg/kg) was measured according to JIS L 1041.5.3.1.B, 2.4 pentanedione method. It was shown that formaldehyde was little contained.

### EXAMPLE 1

### Preparation of a Coating Agent and a Textile According to the Present Invention (I)

Thin textile fabric is selected from nylon and polyester, and a pretreatment such as refining, dyeing and water repelling is firstly performed.

A water dispersed polyurethane resin mixture comprising 30% by weight of polyol using aliphatic isocyanate, 0.5% by weight of triethylamine as a chain extender, 2% by weight of N-methyldiethanolamine as an ionomer, and 67.5% by weight of water was prepared, a thickener comprising 30% by weight of alkaline copolymer compound, 1.5% by weight of alkaline polyoxyethylene sodium sulfate, 0.07% by weight of potassium sulfate and 68.43% by weight of water was prepared, 4.5% by weight of thickener and 50% by weight of water were mixed per 100% by weight of the water dispersed polyurethane resin mixture, and the mixture was stirred thereby preparing a coating agent having a viscosity of 7,000 cps.

20 to 50 g/yard of the coating agents in wet state were applied to the textile fabric with a float knife or air knife, the coated textile was dried in heat drier at 130 to 150° C. for 40 to 90 seconds, and then was hardened at 130 to 170° C. for 30 to 60 seconds.

To confirm the functionality of the textile after the first coating process, an experiment was entrusted to Korea Yarn & Fabric Inspection Testing Institute. From the experiment, it was confirmed that water-proofness level was 500 to 1,000 mm, moisture permeability level was 4,000 to 7,000 g/m²/24 h, and thus cleaning durability, in particular, dry cleaning compatibility is excellent.

### EXAMPLE 2

### Preparation of a Coating Agent and a Textile According to the Present Invention (II)

Thick textile fabric is selected from nylon and polyester, and a pretreatment such as refining, dyeing and water repelling is firstly performed.

Water dispersed polyurethane resin mixture comprising 30% by weight of polyol using aliphatic isocyanate, 0.5% by weight of triethylamine as a chain extender, 2% by weight of N-methyldiethanolamine as an ionomer, and 67.5% by weight of water was prepared, a thickener comprising 30% by weight of alkaline copolymer compound, 1.5% by weight of alkaline polyoxyethylene sodium sulfate, 0.07% by weight of potassium sulfate and 68.43% by weight of water was prepared, 3% by weight of thickener and 50% by weight of water were mixed per 100% by weight of the water dispersed polyurethane resin mixture, and the mixture was stirred thereby preparing a coating agent having a viscosity of 6,000 cps.

20 to 50 g/yard of the coating agents in wet state were applied to the textile fabric with a float knife or air knife, the coated textile was dried in heat drier at 130 to 150° C. for 40 to 90 seconds, and then was hardened at 130 to 170° C. for 30 to 60 seconds.

To confirm the functionality of the textile after the first coating process, an experiment was entrusted to Korea Yarn & Fabric Inspection Testing Institute. From the experiment, it was confirmed that water proofness level was 400 to 1,000 mm, moisture permeability level was 4,000 to 8,000 g/m²/24 h, and thus cleaning durability, in particular, dry cleaning compatibility is excellent.

### EXAMPLE 3

### Preparation of a Coating Agent and a Fiber According to the Present Invention and a Fiber (III)

Mixed fabric is selected from nylon/cotton, polyester/cotton and polyester microfiber, and a pretreatment such as refining, dyeing and water repelling is firstly performed.

A water dispersed polyurethane resin mixture comprising 30% by weight of polyol using aliphatic isocyanate, 0.5% by weight of triethylamine as a chain extender, 2% by weight of N-methyldiethanolamine as an ionomer, and 67.5% by weight of water was prepared, a thickener comprising 30% by weight of alkaline copolymer compound, 1.5% by weight of alkaline polyoxyethylene sodium sulfate, 0.07% by weight of potassium sulfate and 68.43% by weight of water was prepared, 5% by weight of thickener and 80% by weight of water were mixed per 100% by weight of the water dispersed polyurethane resin mixture, and the mixture was stirred thereby preparing a coating agent having a viscosity of 5,000 cps.

20 to 50 g/yard of the coating agents in wet state were applied to the textile fabric with a float knife or air knife, the coated textile was dried in heat drier at 130 to 150° C. for 40 to 90 seconds, and then was hardened at 130 to 170° C. for 30 to 60 seconds.

To confirm the functionality of the textile after the first coating process, an experiment was entrusted to Korea Yarn & Fabric Inspection Testing Institute. From the experiment, it was confirmed that water proofness level was 400 to 1,000 mm, moisture permeability level was 4,000 to 7,000 g/m²/24 h, and thus cleaning durability, in particular, dry cleaning compatibility is excellent.

### EXAMPLE 4

### Coating Twice According to the Present Invention

Base coating was once performed under the same condition as Example 1, and top coating was once performed under the same condition as Example 3.

To confirm the functionality of the textile after the second coating process, an experiment was entrusted to Korea Yarn & Fabric Inspection Testing Institute. From the experiment, it was confirmed that water proofness level was 600 to 5,000 mm H₂O, moisture permeability level was 2,000 to 5,000 g/m²/24 h, and thus cleaning durability, in particular, dry cleaning compatibility is excellent.

For a textile requiring much cleaning durability and adhesiveness in an embodiment of the various textiles, 1 to 3% by weight of aliphatic epoxy crosslinking agent relative to 100% by weight of a water-dispersed polyurethane resin mixture was added. The aliphatic epoxy crosslinking agent enhanced the strength of peeling the textile even though formalin was not detected. If the crosslinking agent was excessively, i.e., more than 3%, used, the peeling strength was enhanced, however, touch feel became rough and softness was decreased. If the crosslinking agent was used below 1%, it was difficult to obtain sufficient peeling strength.

Further, defoaming foams, usually generated when combining resins, naturally and mechanically, is very crucial since uniform and smooth coat surface can be obtained during drying process. However, the working mechanism of a defoamer is complicated, and thus difficult to elucidate, and it is not easy to select a proper defoamer among various defoamers. In the present invention, in consideration with in situ productivity and workability, cumbersome defoaming process can be avoided by adding 0.5 to 1.0% by weight of an aqueous silicone defoamer per 100% by weight of a water-dispersed polyurethane resin mixture. It must be noted that when a defoamer is used in greater amounts, defoaming effect is excellent; however, peeling strength can be decreased.

Meanwhile, moisture permeability, aerating property, and anion and far infrared function, etc. can be further imparted by adding 3 to 50% by weight of a zeolite having a diameter of 3 to 5μm essentially consisting of SiO₂, Al₂O₃ and Na₂O per 100% by weight of the coating agent prepared as described above.

Further, electronic wave blocking and antistatic function can be imparted to a textile by further adding 5 to 25% by weight of carbon powders having a diameter of 3 to 5 μm and a purity of 90 to 99.9% per 100% by weight of the coating agent; and a fragrance can be generated from the textile by further adding 0.5 to 5% by weight of a fragrance capsule per 100% by weight of the coating agent. In particular, microcapsule is disrupted by oil for an oil coating agent; however, an aqueous coating agent according to the present invention does not disrupt a capsule, thereby maintaining its fragrance for a long time.

In addition, one or more of an anti-bacterial agent, a smell removing agent and a deodorant can be selected and added in the amount of 1 to 50% by weight per 100% by weight of a coating agent, and the coating agent can be coated on a textile and its coated product can be used as a cloth, a wallpaper and a hospital sheet, etc.

Further, an aqueous pigment can be added in the amount of 1 to 50% by weight per 100% by weight of a coating agent to express various colors, an aqueous silicone can be further added in the amount of 5 to 80% by weight per 100% by weight of a coating agent to enhance strength and elasticity, and pearl powders can be further added in the amount of 0.1 to 10% by weight per 100% by weight of a coating agent to let a textile surface glittered.

Even when an additive such as zeolite is further added to the coating agent as described above, a coating agent in which an additive such as zeolite was added as described above is applied to a pretreated textile in a thickness of 20 to 100 g/yds with a float knife or an air knife, and the coated product is heat-dried at 130 to 150° C. for 40 to 90 seconds, and is hardened at 130 to 170° C. for 30 to 60 seconds thereby completing coating on the textile.

Although the present invention has been described with reference to several embodiments of the invention, the description is illustrative of the invention and is not to be construed as limiting the invention. Various modifications and variations may occur to those skilled in the art, without departing from the spirit and scope of the invention as defined by the appended claims.

1. A method of coating a textile employing aqueous polyurethane having excellent water proofness and moisture permeability comprising:
preparing a water dispersed polyurethane resin mixture comprising 30 to 50% by weight of a polyol using aliphatic isocyanate, 0.4 to 1% by weight of tri-ethylamine as a chain extender, 2 to 3% by weight of N-methyldiethanolamine as an ionomer, and 46 to 67.5% by weight of water;
preparing a thickener comprising 28 to 30% by weight of an alkaline copolymer compound, 1 to 2% by weight of alkaline polyoxyethylene sodium sulfate, 0.05 to 0.1% by weight of potassium sulfate and 67.9 to 70.95% by weight of water;
mixing 3 to 5% by weight of a thickener and 30 to 80% by weight of water per 100% by weight of the water dispersed polyurethane resin mixture, and stirring the mixture thereby preparing an aqueous urethane coating agent; and
then the aqueous urethane coating agent is applied to a pretreated textile fabric in a thickness of 20 to 100 g/yds with the float knife or air knife, and then the coated textile fabric is dried in a heat drier at 130 to 150° C. for 40 to 90 seconds, and then is hardened at 130 to 170° C. for 30 to 60 seconds.

2. The method according to claim 1, wherein the viscosity of the aqueous urethane coating agent is 5,000 to 10,000 cps.

3. The method according to claim 1, wherein an epoxy crosslinking agent is added in the amount of 1 to 3% by weight per 100% by weight of the aqueous urethane coating agent.

4. The method according to claim 1, wherein an aqueous silicone defoamer is added in the amount of 0.5 to 1% by weight per 100% by weight of the aqueous urethane coating agent.

5. The method according to claim 1, wherein zeolite is further added in the amount of 3 to 50% by weight per 100% by weight of the aqueous urethane coating agent.

6. The method according to claim 1, wherein carbone powders are further added in the amount of 5 to 25% by weight per 100% by weight of the aqueous urethane coating agent.

7. The method according to claim 1, wherein a fragrance capsule is further added in the amount of 0.5 to 5% by weight per 100% by weight of the aqueous urethane coating agent.

8. The method according to claim 1, wherein one or more of an anti-bacterial agent, a smell removing agent and a deodorant are mixed and further added in the amount of 1 to 50% by weight per 100% by weight of the aqueous urethane coating agent.

9. The method according to claim 1, wherein an aqueous pigment is further added in the amount of 1 to 50% by weight per 100% by weight of the aqueous urethane coating agent.

10. The method according to claim 1, wherein aqueous silicone is further added in the amount of 5 to 80% by weight per 100% by weight of the aqueous urethane coating agent.

11. The method according to claim 1, wherein pearl powders are further added in the amount of 0.1 to 10% by weight per 100% by weight of the aqueous urethane coating agent.

12. The method according to claim 2, wherein an epoxy crosslinking agent is added in the amount of 1 to 3% by weight per 100% by weight of the aqueous urethane coating agent.

13. The method according to claim 2, wherein an aqueous silicone defoamer is added in the amount of 0.5 to 1% by weight per 100% by weight of the aqueous urethane coating agent.
